(19) United States
(12) Patent Application Publication
(10) Pub. No.: US 2026/0178506 A1
(43) Pub. Date: Jun. 25, 2026

(54) DETECTING AND PREVENTING VIRTUAL ADDRESS ALIASING TO THE SAME PHYSICAL ADDRESS

(71) Applicant: Google LLC, Mountain View, CA (US)

(72) Inventor: Sadayan Ghows Ghani Sadayan Ebramsah Mo Abdul, Austin, TX (US)

(21) Appl. No.: 19/126,036

(22) PCT Filed: Dec. 23, 2022
(86) PCT No.: PCT/US2022/053982

§ 371 Date: Apr. 30, 2025

(51) Int. Cl. G06F 12/0895

(52) U.S. Cl. CPC G06F 12/0895

(57) ABSTRACT

Methods, systems, and apparatus, including computer programs encoded on computer storage media, for detecting virtual address aliasing. One of the methods includes maintaining, by a primary cache structure, a mapping between virtual addresses and cache sets. An anti-aliasing cache structure maintains a mapping between virtual addresses and hashes of corresponding physical addresses stored in the primary cache structure. The anti-aliasing cache structure is used to identify all instances of a particular physical address stored in the primary cache structure.

### BACKGROUND

This specification is related to systems containing integrated circuit devices.

Caches are auxiliary devices that manage data traffic to memory. A cache interacts with one or more hardware devices in a system to store data retrieved from memory, or store data that is to be written to memory, or both. The hardware devices can be various components of an integrated circuit and be implemented into a system on a chip (SOC). Devices that supply read and write requests through caches, or directly to memory, will be referred to as client devices.

A cache is frequently utilized to reduce power consumption by limiting the total number of requests to main memory. Further power savings can be achieved by placing the main memory and the data pathways to main memory in a lowered power state. Due to the inverse correlation between cache usage and power consumption, maximizing cache usage leads to an overall decrease in power consumed. The power capacity of battery powered devices, e.g., mobile computing devices, can be spent more efficiently by increasing cache usage of integrated client devices. Moreover, accessing the cache is generally faster than accessing the main memory, thereby increasing the performance of the integrated client devices.

Caches are commonly organized into multiple sets having multiple ways. A cache can be divided into groups of blocks, and each group of blocks can be called a set. Each block can also be called a line. The memory address of a request can be used to identify a particular set in the cache. Each set contains one or more ways or degrees of associativity. Each way includes a data block and the valid and tag bits. For example, a two-way associative cache can have two data blocks.

Some client devices can have a hierarchy of multiple cache levels. The hierarchy of multiple cache levels can include “lower-level” caches and “higher-level” caches. For example, the lower-level caches can include a Level 1 (L1) cache, and the higher-level caches can include a Level 2 (L2) cache. The lower-level caches can have a smaller number of blocks, smaller block size, fewer blocks in a set, or a combination of these, but have very short access times. The higher-level caches, e.g., Level 2 and above, can have progressively larger number of blocks, larger block size, more blocks in a set, or a combination of these, and relatively longer access times, but are still much faster than the main memory.

At any given time, a physical address (PA) in a higher-level cache should only map to one way of a unique virtual address (VA) in the lower-level cache. For example, there should be no duplicates in the L1 cache. If one of the ways of the L1 cache is modified with new data, the other way of the L1 cache with the same PA would now have stale data and would break coherency.

In some devices, the lower-level caches can be virtually indexed and can share some bits with the physically indexed higher-level cache. As the size of the lower-level cache increases, the system may have to use more bits to address the lower-level cache. Therefore, some VA bits would be used in the lower-level cache indexing and would not match with the PA bits at the same bit location that the higher-level cache would be using to index into the higher-level cache. This can result in a scenario where multiple virtual addresses would be mapped to the same PA, e.g., resident in multiple L1 ways. This scenario will be referred to as virtual address (VA) aliasing.

Some systems can detect virtual address aliasing by checking each possible location in the lower-level cache and determine if a particular physical address is in two or more locations. However, this method requires multiple readings of the lower-level cache, e.g., reading the static random-access memory (SRAM). For example, reading two sets of VA in L1 cache can be a two cycle operation, decreasing the performance of the integrated client devices.

Some systems can store the VA bits that are beyond the PA bits into a higher-level cache, e.g., L2 cache. If a new VA is used to access the same PA, the system can use the higher-level cache to identify the VA aliasing and can remove the other way in the lower-level cache, e.g., L1 cache, that is holding the same PA. However, this method adds a lot of bits into the higher-level cache tag structure and increases the area required for the L2 tag. This method also increases the latency because calling the higher-level cache may be an operation that takes several cycles, e.g., 10 cycles.

Some systems can increase the number of ways in a single set of the lower-level cache to reduce the number of sets, thus reducing the number of bits required to index the sets. However, this may not be a viable solution in many cases due to the increased cost of comparing multiple ways in a set.

### SUMMARY

This specification describes techniques for detecting and preventing virtual address aliasing to the same physical address in a virtually indexed lower-level cache. The techniques use an anti-aliasing cache structure associated with the lower-level cache structure to identify a potential aliasing issue.

The anti-aliasing cache structure can be configured to maintain a mapping between virtual addresses and hashes of corresponding physical addresses stored in the lower-level cache structure. The anti-aliasing cache structure can be stored locally on the lower-level cache, e.g., L1 cache, and can be indexed based on the physical address. A control logic of the lower-level cache system can be configured to use the anti-aliasing cache structure to identify all instances of a particular physical address stored in the lower-level cache structure.

Particular embodiments of the subject matter described in this specification can be implemented so as to realize one or more of the following advantages. The cache system of the lower-level cache can speed up the detection of virtual address aliasing. Instead of reading multiple sets of a lower-level cache in multiple cycles, the cache system can read the anti-aliasing cache structure in one cycle to identify aliasing. The cache system can save power consumption required for the detection of virtual address aliasing. Instead of accessing the higher-level cache from the lower-level cache, which usually takes more power and multiple cycles to read, the cache system can read the anti-aliasing cache structure that is stored locally in the lower-level cache, reducing the power consumption and the improving the speed of the detection of virtual address aliasing. The cache system can use the locally stored anti-aliasing cache structure to prevent virtual address aliasing to the same physical address, e.g., in virtually indexed L1 cache without using the L2 cache for tracking the previously accessed virtual addresses. This structure can also be used as a way predictor because the way information can be derived from the physical address indexed table.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of an example system.

FIG. 2 is a flowchart of an example process for detecting virtual address aliasing.

Like reference numbers and designations in the various drawings indicate like elements.

### DETAILED DESCRIPTION

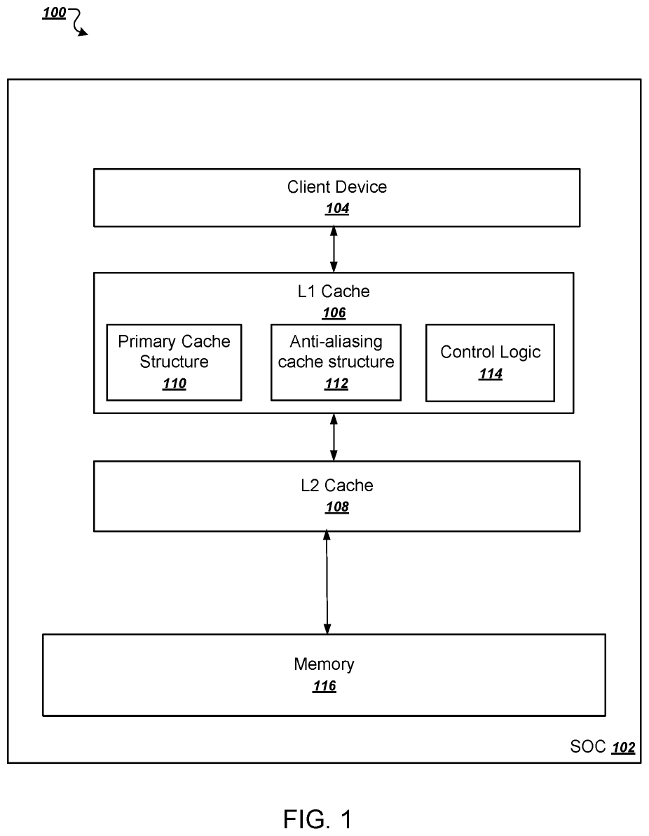

FIG. 1 is a diagram of an example system 100. The system 100 includes a client device 104 that provides memory requests for locations in a memory device 116. The client device 104 and the memory 116 can be integrated onto a single system on a chip (SOC) 102. The client device 104 or the SOC 102 itself can be a central processing unit (CPU), a graphics processing unit (GPU), a tensor processing unit (TPU), an ambient computing module, an image processor, a sensor processing module, an application-specific integrated circuit (ASIC), or other lower-level components of the SOC 102 itself that are capable of issuing memory requests to the memory 116.

The SOC 102 is an example of a device that can be installed on or integrated into any appropriate computing device, which may be referred to as a host device. Because the techniques described in this specification are particularly suited to reducing power consumption and increasing performance for the host device, the SOC 102 can be especially beneficial when installed on mobile host devices that rely on battery power, e.g., a smart phone, a smart watch or another wearable computing device, a tablet computer, or a laptop computer, to name just a few examples.

The system 100 can include one or more levels of cache that caches data requests for the client device 104 on the SOC 102. The system 100 can include a lower-level cache, e.g., the Level 1 (L1) cache 106, and a higher-level cache, e.g., the Level 2 (L2) cache 108. The lower-level caches can have a smaller number of blocks, smaller block size, fewer blocks in a set, or a combination of these, but have very short access times. The higher-level caches, e.g., Level 2 and above, can have progressively larger number of blocks, larger block size, more blocks in a set, or a combination of these, and relatively longer access times, but are still much faster than the main memory.

For example, the client device 104 can be a CPU and the CPU can have a hierarchy of multiple cache levels, e.g., the L1 cache 106 and the L2 cache 108, with different instruction-specific and data-specific caches at the L1 cache. The cache memory can be implemented with static random-access memory (SRAM), or other types of memories. In some implementations, in an inclusive L2 design, all L1 lines can be resident in the L2 cache.

A physical address (PA) is what is actually used to store the data in the memory 116 or on a hard disk. At any given time, a physical address in a higher-level cache should only map to one way of a unique virtual address (VA) in the lower-level cache. For example, there should be no duplicates in the L1 cache 106. If one of the ways of the L1 cache 106 is modified with new data, the other way of the L1 cache with the same PA would now have stale data and would break coherency.

In many devices, the lower-level caches can be virtually indexed and can share some bits with the physically indexed higher-level cache. For example, the system 100 can have a 4 KB page size. The lower 12 bits can be unmodified. This allows the virtually indexed L1 cache 106 to share some bits with the physically indexed L2 cache 108.

As the size of the lower-level cache increases, the system may have to use more bits to address the lower-level cache. For example, given the increasing size of the L1 cache 106, more than the lower 12 bits would have to be used to address the L1 cache 106. Therefore, some VA bits would be used in the lower-level cache indexing and would not match with the PA bits at the same bit location that the higher-level cache would be using to index into the higher-level cache. This can result in a scenario where multiple virtual addresses would be mapped to the same PA, e.g., resident in multiple L1 ways. This scenario will be referred to as virtual address (VA) aliasing.

For example, an android operating system can run two applications. The two applications are both accessing the same base system function. The base system function can be out in the physical memory 116 at physical address A. Each of these two applications is allotted to a different virtual memory space in the L1 cache 106. The first application can have a virtual memory space from B0 to B5 and the second application can have a virtual memory space from C0 to C5. Therefore, it is possible that virtual address B0 and virtual address C0 in the L1 cache are both mapped to the same physical address A, accessing the same base system function.

The lower-level cache, e.g., the L1 cache 106, can have a cache system configured to detect VA aliasing. The cache system can include a primary cache structure 110 that can be configured to maintain a mapping between virtual addresses and cache sets. The cache system can include an anti-aliasing cache structure 112 that can be configured to maintain a mapping between virtual addresses and hashes of corresponding physical addresses stored in the primary cache structure 110. The cache system can include control logic 114 that can be configured to use the anti-aliasing cache structure 112 to identify all instances of a particular physical address stored in the primary cache structure 110.

Table 1 illustrates an example of a primary cache structure 110 in an L1 cache.

TABLE 1

| Set number | Way 0 | Way 1 |
|---|---|---|
| VA[12:5] = 255 | PA of L1D set255, way0 | PA of L1D set255, way1 |
| VA[12:5] = 173 | PA of L1D set173, way0 | PA of L1D set173, way1 |
| VA[12:5] = 128 | PA of L1D set128, way0 | PA of L1D set128, way1 |
| VA[12:5] = 127 | PA of L1D set127, way0 | PA of L1D set127, way1 |
| VA[12:5] = 45 | PA of L1D set45, way0 | PA of L1D set45, way1 |
| VA[12:5] = 0 | PA of L1D set0, way0 | PA of L1D set0, way1 |

The L1 cache has 256 sets and each set has two ways, e.g., “way 0” and “way 1”. Each way has a block size of 32 B and is indexed by 5 bits, e.g., VA[4:0]. The 256 sets can be indexed by 8 VA bits, e.g., VA[12:5].

The L1 cache can share some bits with the physically indexed L2 cache. During a translation from a VA to a PA, a subset of bits of the VA are the same. In this example, the L1 cache shares the lower 12 bits, e.g., VA[11:0], with the physically indexed L2 cache. Thus, assuming a 4 KB minimum page size, only VA[11:0] is maintained when generating a PA, e.g., translating to a PA. Here, VA[12] is used for the indexing into the L1 cache. Therefore, VA[12]=0 can map to PA[12]=0 or PA[12]=1, and VA[12]=1 can map to PA[12]=0 or PA[12]=1.

Therefore, multiple VA combinations can potentially map to the same PA, resulting in VA aliasing. For example, the PA for VA[12:5]=255 (8′b1111_1111) could map to PA of 011_11, and the PA for VA[12:5]=127 (8′b0111_1111) could map to the same PA of 0111_1111. When translating from VA to PA, bits 11 to 0 does not change and bit 12 is the only bit that can change. Thus, two different VAs, e.g., two different sets, can map to the same PA. PA 0111_1111 is not unique in the L1 cache 106.

Because each set has two ways, there are four ways in total that can store the same PA. For example, PA of 0111_1111 can map to (set 255, way 0), (set 255, way 1), (set 127, way 0), and (set 127, way 1). If these four ways can be protected, the system won't have an aliasing issue. Similarly, set 0 and set 128 could alias, set 1 and set 129 could alias, . . . , set 127 and set 255 could alias.

The example in Table 1 illustrates VA that has one bit that can change when mapping to PA. In some implementations, when the size of the cache increases, multiple bits of a VA can change when mapping to PA. For example, VA[14:5] can be used to index the sets in the L1 cache. When translating from VA to PA, bits 11 to 0 do not change and the three bits 14:12 can change. So a particular PA could map to one of 8 possible VA sets, e.g., VA[14:12]=000, 001, . . . , 111.

Table 2 illustrates an example anti-aliasing cache structure 112 in the L1 cache. The cache system of the L1 cache 106 can use the anti-aliasing cache structure to identify a potential aliasing.

TABLE 2

| Set number | Group 0 | Group 1 |
|---|---|---|
| VA[11:5] = | {pahash[L1D set127- | {pahash[L1D set255- |
| 127 | way0], | way0], |
| | pahash[L1D set127-way1]} | pahash[L1D set255-way1]} |
| VA[11:5] = | {pahash[L1D set45-way0], | {pahash[L1D set173-way0], |
| 45 | pahash[L1D set45-way1]} | pahash [L1D set173-way1]} |
| VA[11:5] = | {pahash[L1D set0-way0], | {pahash[L1D set128-way0], |
| 0 | pahash[L1D set0-way1]} | pahash[L1D set128-way1]} |

The example anti-aliasing cache structure 112 is configured to maintain a mapping between VAs and hashes of corresponding PAs (namely “pahash”) stored in the example primary cache structure in Table 1. The VAs in Table 2 are indexed by a subset of bits, e.g., the lower bits, that do not change when translating VAs into PAs. For example, bits in VA[11:5] do not change for VA[12:5]=255 and VA[12:5]=127. The VAs in Table 2 are indexed by VA[11:5] with a total of 7 addressing bits and 128 entries.

Each entry in Table 2 can hold as many ways as the aliasing sets. In the example anti-aliasing cache structure 112 in Table 2, each entry can hold two ways. Each of the ways of the anti-aliasing cache structure can hold a hash of the PA of each of the two ways in the L1 primary cache structure in Table 1.

For example, as discussed above, PA of 0111_1111 can map to (set 255, way 0), (set 255, way 1), (set 127, way 0), and (set 127, way 1). The four ways mapping to VA[11:5]=127 are stored in one entry, e.g., the entry indexed by VA[11:5]=127 which is the first row in Table 2. The entry indexed by VA[11:5]=127 includes way 0 and way 1. Way 0 includes the PA hash of L1 cache set 127 way 0 (e.g., pahash[L1D set127-way0]), and the PA hash of L1 cache set 127 way 1 (e.g., pahash[L1D set127-way1]). Way 1 includes the PA hash of L1 cache set 255 way 0 (e.g., pahash[L1D set255-way0]), and the PA hash of L1 cache set 255 way 1 (e.g., pahash[L1D set255-way1]). So one read of VA[11:5] in Table 2 can result in four different PA hashes.

The cache system of the L1 cache 106 can include control logic 114 that can be configured to use the anti-aliasing cache structure 112 to identify all instances of a particular physical address stored in the primary cache structure 110.

The cache system can obtain a particular physical address. The cache system can compute a hash of the particular physical address. Generally, hashing is the process of transforming any given key or a string of characters into another value. Hashing can be performed using a hash function. The hash function is a function that can be used to map data of arbitrary size to fixed-size values. The values returned by a hash function are called hash values, or simply hashes. The hash of the PA can be several bits, e.g., 5 bits, 12 bits, or 24 bits. Hashing is a fast calculation that can be computed in a single cycle.

The cache system can determine, using the anti-aliasing cache structure 112, whether two or more virtual addresses map to the hash of the particular physical address. Because the sets and ways with potential aliasing have been collapsed in a single data entry in Table 2, the cache system can read a single data entry corresponding to the particular physical address and can identify whether two or more virtual addresses map to the hash of the particular physical address.

For example, the cache system can index using VA[11:5]=127, e.g., the bits that don't change, and can get four different PA hashes: pahash[L1D set127-way0], pahash[L1D set127-way1], pahash[L1D set255-way0], and pahash[L1D set255-way1]. The cache system can determine whether the hash of the particular physical address is at any of the four possible locations in the L1 cache.

Therefore, rather than checking multiple possible aliasing locations in the L1 cache or accessing the L2 cache, either of which can take two or more cycles, the cache system can detect aliasing in one cycle without going outside of the L1 cache. For example, as shown in the examples in Table 1 and Table 2, instead of a two cycles operation, e.g., reading the VA[12:5]=127 entry in Table 1 in one cycle and reading the VA[12:5]=255 entry in the next cycle, which the system may not afford to do, the cache system can read the VA[11:5]=127 entry in Table 2 in one cycle, speeding up the aliasing detection.

If the cache system determines that two or more virtual addresses map to the hash of the particular physical address, the cache system can determine that the two or more virtual addresses have aliasing. For example, the cache system can determine that both pahash[L1D set127-way1] and pahash[L1D set255-way0] are equal to the hash of the particular physical address. In response, the cache system can determine that the two virtual addresses have aliasing.

If the cache system determines that none of two virtual addresses map to the hash of the particular physical address, the cache system can determine that there is no virtual address aliasing for the particular physical address. For example, the cache system can determine that only one pahash stored in the VA[11:5]=127 entry equals the hash of the particular physical address, or none of the pahashes are equal to the hash of the particular physical address. In response, the cache system can determine that there is no virtual address aliasing for the particular physical address.

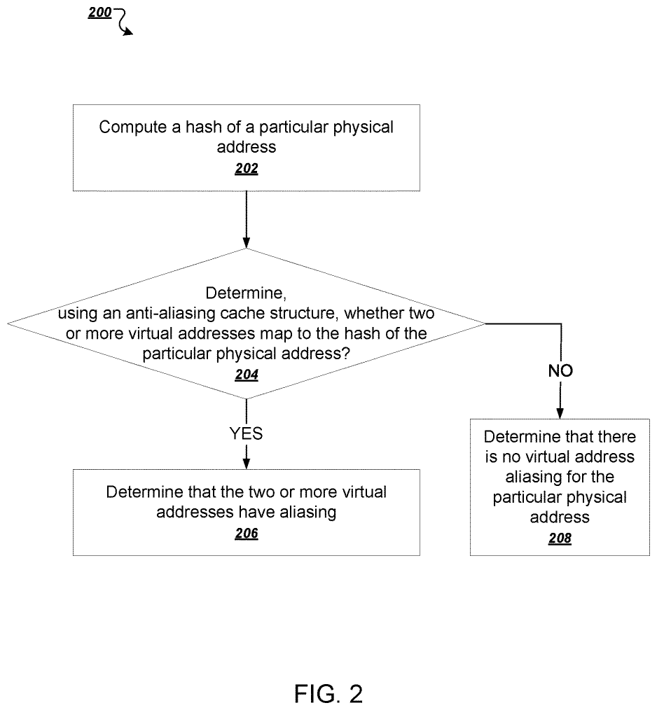

FIG. 2 is a flowchart of an example process 200 for detecting virtual address aliasing. The example process 200 can be performed by one or more components of a cache. The example process 200 will be described as being performed by control logic of a lower-level cache on an SOC, e.g., the control logic 114 of the L1 cache 106 of the SOC 102, programmed appropriately in accordance with this specification.

The cache system can include a primary cache structure that can be configured to maintain a mapping between virtual addresses and cache sets. The cache system can include an anti-aliasing cache structure that can be configured to maintain a mapping between virtual addresses and hashes of corresponding physical addresses stored in the primary cache structure. The cache system can include a control logic that can be configured to use the anti-aliasing cache structure to identify all instances of a particular physical address stored in the primary cache structure.

The control logic computes a hash of a particular physical address (202). The control logic determines, using an anti-aliasing cache structure, whether two or more virtual addresses map to the hash of the particular physical address (204).

In some implementations, the anti-aliasing cache structure can be indexed by a subset of bits of a virtual address, and the subset of bits are the same during a translation from the virtual address to a corresponding physical address. For example, in Table 1, the VA[12] bit can change during a translation from VA to PA, and the bits of VA[11:5] do not change during the translation. The control logic can index the anti-aliasing cache structure in Table 2 by the VA[11:5] bits of the virtual address VA[12:5].

In response to determining that the two or more virtual addresses map to the hash of the particular physical address, the control logic determines that the two or more virtual addresses have aliasing (206). In response to determining that none of the two or more virtual addresses map to the hash of the particular physical address, the control logic determines that there is no virtual address aliasing for the particular physical address (208).

In some implementations, the control logic can be configured to use the anti-aliasing cache structure to identify all the instances of the particular physical address stored in the primary cache structure in a single cycle. Because the sets and ways with potential aliasing have been collapsed in a single data entry in the anti-aliasing cache structure, the control logic can read a single data entry corresponding to the particular physical address and can identify whether two or more virtual addresses map to the hash of the particular physical address.

In some implementations, the control logic can be configured to remove the aliasing of the two or more virtual addresses. For example, after detecting aliasing of the two or more virtual addresses, the control logic can evict one or more virtual addresses of the two or more aliasing virtual addresses, and can keep a single virtual address that maps to the particular physical address. For example, if the control logic determines that (set 127, way 0) and (set 255, way 0) both map to the same PA=A, the control logic can fill the location at (set 255, way 0) with “empty” or “invalid”. Therefore, only (set 127, way 0) maps to the PA=A.

In some implementations, the control logic can be configured to prevent aliasing by updating the primary cache structure. In some implementations, the control logic can receive a request to fill a particular physical address into a first virtual address. The control logic can compute a hash of the particular physical address. The control logic can determine, using the anti-aliasing cache structure, that a second virtual address maps to the hash of the particular physical address. The control logic can evict, in the primary cache structure, the second virtual address. The control logic can fill, in the primary cache structure, the particular physical address into the first virtual address. Therefore, there is no virtual address aliasing for the particular physical address because the particular physical address only maps to a single virtual address.

For example, referring to Table 1, set VA[12:5]=255 and set VA[12:5]=127 of L1 cache can have potential aliasing. Table 3 illustrates an example primary cache structure 110 in an L1 cache with example physical addresses. The location (set 255, way 0) stores PA=A. The location (set 255, way 1) stores PA=C. The location (set 127, way 0) stores PA=B. The location (set 127, way 1) stores PA=D.

TABLE 3

| Set number | Way 0 | Way 1 |
|---|---|---|
| VA[12:5] = | PA of L1D set255, | PA of L1D set255, |
| 255 | way0 = A | way1 = C |
| VA[12:5] = 173 | PA of L1D set173, way0 | PA of L1D set173, way1 |
| VA[12:5] = 128 | PA of L1D set128, way0 | PA of L1D set128, way1 |
| VA[12:5] = 127 | PA of L1D set127, | PA of L1D set127, |
| | way0 = B | way1 = D |
| VA[12:5] = 45 | PA of L1D set45, way0 | PA of L1D set45, way1 |
| VA[12:5] = 0 | PA of L1D set0, way0 | PA of L1D set0, way1 |

Table 4 illustrates an example anti-aliasing cache structure 112 in the L1 cache with example hashes of physical addresses. The respective hashes of the PAs A, B, C, and D are A′, B′, C′, and D′. Thus, in Table 4, the entry indexed by VA[11:5]=127 includes {pahash[L1D set127-way0]=B′, pahash[L1D set127-way1]=D′} in way 0, and {pahash[L1D set255-way0]=A′, pahash[L1D set255-way1]=C′} in way 1.

TABLE 4

| Set number | Group 0 | Group 1 |
|---|---|---|
| VA[11:5] = | {pahash[L1D set127- | {pahash [L1D set255- |
| 127 | way0] = B′, | way0] = A′, |
| | pahash[L1D set127- | pahash [L1D set255- |
| | way1] = D′} | way1] = C′} |
| VA[11:5] = | {pahash[L1D set45-way0], | {pahash[L1D set173-way0], |
| 45 | pahash [L1D set45-way1]} | pahash[L1D set173-way1]} |
| VA[11:5] = | {pahash[L1D set0-way0], | {pahash[L1D set128-way0], |
| 0 | pahash [L1D set0-way1]} | pahash[L1D set128-way1]} |

The L1 cache, e.g., the control logic of the L1 cache, can receive a request to fill a particular physical address into a first virtual address in the L1 cache. For example, the control logic can receive a request to fill PA=C into the virtual address VA[12:5]=127. The control logic can compute a hash of the particular physical address. For example, the control logic can determine that the hash of PA=C is C′.

The control logic can determine, using the anti-aliasing cache structure, that a second virtual address currently maps to the hash of the particular physical address. For example, the control logic can index the anti-aliasing cache structure in Table 4 using the lower bits of the virtual address, e.g., VA[11:5]=127. The control logic can obtain the entry indexed by VA[11:5]=127 in a single cycle.

Using the entry indexed by VA[11:5]=127, the control logic can identify that the hash C′ is in (set 255, way 1) of VA[12:5]=255. The location at (set 255, way 1) is different from the target location (set 127, way 1) to fill PA=C. If the cache system fills (set 127, way 1) with PA=C, there would be virtual address aliasing because both (set 127, way1) and (set 255, way 1) would map to the same physical address.

The control logic can prevent aliasing by updating the primary cache structure in Table 3. The control logic can evict, in the primary cache structure, the second virtual address. The control logic can fill, in the primary cache structure, the particular physical address into the first virtual address.

Table 5 illustrates an example primary cache structure 110 in an L1 cache after the updating. The control logic can evict the location at (set 255, way 1), e.g., removing the PA=C stored at (set 255, way 1), setting it to “invalid”, or a combination of both. In some implementations, the control logic can write the PA stored in the second virtual address back to the higher-level cache. For example, the control logic can write PA=C at location (set 255, way 1) back to the L2 cache 108.

TABLE 5

| Set number | Way 0 | Way 1 |
|---|---|---|
| VA[12:5] = | PA of L1D set255, | PA of L1D set255, way1 = |
| 255 | way0 = A | C −> kicked out (evicted) |
| VA[12:5] = 173 | PA of L1D set173, way0 | PA of L1D set173, way1 |
| VA[12:5] = 128 | PA of L1D set128, way0 | PA of L1D set128, way1 |
| VA[12:5] = 127 | PA of L1D set127, | PA of L1D set127, |
| | way0 = B | way1 = D(evicted) −> C |
| VA[12:5] = 45 | PA of L1D set45, way0 | PA of L1D set45, way1 |
| VA[12:5] = 0 | PA of L1D set0, way0 | PA of L1D set0, way1 |

The control logic can fill the physical address PA=C into the virtual address VA[12:5]=127. The control logic can select either the location (set 127, way 0) or the location (set 127, way 1) to store the PA=C. In some implementations, the control logic can randomly select one of the locations to store the particular physical address. For example, in Table 5, the control logic can select (set 127, way 1) to store the PA=C. The control logic can evict PA=D currently stored in (set 127, way 1), and then can fill (set 127, way 1) with PA=C.

In some implementations, the control logic can write the PA currently stored in the first virtual address back to the higher-level cache and then can fill the particular physical address into the first virtual address. For example, the control logic can write PA=D at location (set 127, way 1) back to the L2 cache 108 and then can fill PA=C into the location (set 127, way 1).

In some implementations, the control logic can be configured to further update the anti-aliasing cache structure. The control logic can evict, in the anti-aliasing cache structure, the hash of the particular physical address associated with the second virtual address. The control logic can associate, in the anti-aliasing cache structure, the hash of the particular physical address with the first virtual address.

Table 6 illustrates an example anti-aliasing cache structure 112 in the L1 cache after the updating. The control logic can evict, in the anti-aliasing cache structure, the hash of the particular physical address associated with the second virtual address. For example, the control logic can set the pahash of (set 255, way 1) to “empty” or “invalid”. The control logic can associate, in the anti-aliasing cache structure, the hash of the particular physical address with the first virtual address. For example, the control logic can associate the hash C′ of PA=C with the location (set 127, way 1) at the virtual address VA[12:5]=127. Thus, in Table 6, pahash[L1D set 127-way1]=C′ and pahash[L1D set 255-way1]=empty.

TABLE 6

| Set number | Group 0 | Group 1 |
|---|---|---|
| VA[11:5] = | {pahash[L1D set127- | {pahash[L1D set255- |
| 127 | way0] = B′, | way0] = A′, |
| | pahash[L1D set127- | pahash [L1D set255- |
| | way1] = D′ −> C′} | way1] = C′ −> empty} |
| VA[11:5] = | {pahash[L1D set45-way0], | {pahash[L1D set173-way0], |
| 45 | pahash[L1D set45-way1]} | pahash[L1D set173-way1]} |
| VA[11:5] = | {pahash[L1D set0-way0], | {pahash[L1D set128-way0], |
| 0 | pahash[L1D set0-way1]} | pahash[L1D set128-way1]} |

When an application needs to access the address VA[12:5]=127, the application can obtain PA=C at the location (set 127, way 1). The control logic can find, in Table 6, that the only location who has a pahash=C′ is at (set 127, way 1), which matches the read from the entry VA[12:5]=127 in Table 5. There is no virtual address aliasing because there is no other PA=C stored in the L1 cache 106.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program which may also be referred to or described as a program, software, a software application, an app, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

As used in this specification, an “engine,” or “software engine,” refers to a hardware-implemented or software implemented input/output system that provides an output that is different from the input. An engine can be implemented in dedicated digital circuitry or as computer-readable instructions to be executed by a computing device. Each engine can be implemented within any appropriate type of computing device, e.g., servers, mobile phones, tablet computers, notebook computers, music players, e-book readers, laptop or desktop computers, PDAs, smart phones, or other stationary or portable devices, that includes one or more processing modules and computer-readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a host device having a display device, e.g., a CRT (cathode ray tube) or LCD (liquid crystal display) monitor, for displaying information to the user and a keyboard and pointing device, e.g., a mouse, trackball, or a presence sensitive display or other surface by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

In addition to the embodiments described above, the following embodiments are also innovative:

Embodiment 1 is a method performed by a cache system, the method comprising:
maintaining, by a primary cache structure, a mapping between virtual addresses and cache sets;
maintaining, by an anti-aliasing cache structure, a mapping between virtual addresses and hashes of corresponding physical addresses stored in the primary cache structure, and
using the anti-aliasing cache structure to identify all instances of a particular physical address stored in the primary cache structure.

Embodiment 2 is method of embodiment 1, further comprising using the anti-aliasing cache structure to identify all the instances of the particular physical address stored in the primary cache structure in a single cycle.

Embodiment 3 is the method of any one of embodiments 1-2, further comprising detecting aliasing, comprising:
computing a hash of the particular physical address;
determining, using the anti-aliasing cache structure, that two or more virtual addresses map to the hash of the particular physical address; and
in response to determining that the two or more virtual addresses map to the hash of the particular physical address, determining that the two or more virtual addresses have aliasing.

Embodiment 4 is the method of embodiment 3, wherein the control logic is configured to remove the aliasing of the two or more virtual addresses.

Embodiment 5 is the method of any one of embodiments 1-4, further comprising preventing aliasing, comprising:
receiving a request to fill the particular physical address into a first virtual address;
computing a hash of the particular physical address;
determining, using the anti-aliasing cache structure, that a second virtual address maps to the hash of the particular physical address;
evicting, in the primary cache structure, the second virtual address; and
filling, in the primary cache structure, the particular physical address into the first virtual address.

Embodiment 6 is the method of embodiment 5, wherein preventing the aliasing further comprises:
evicting, in the anti-aliasing cache structure, the hash of the particular physical address associated with the second virtual address; and
associating, in the anti-aliasing cache structure, the hash of the particular physical address with the first virtual address.

Embodiment 7 is the method of any one of embodiments 1-6, wherein the anti-aliasing cache structure is indexed by a subset of bits of a virtual address, and wherein the subset of bits are the same during a translation from the virtual address to a corresponding physical address.

Embodiment 8 is a cache system comprising one or more integrated hardware devices that are operable to perform the method of any one of embodiments 1 to 7.

Embodiment 9 is a storage medium encoded with instructions that when executed by one or more integrated hardware devices cause the one or more hardware devices to perform the method of any one of embodiments 1 to 7.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A cache system comprising:
a primary cache structure that is configured to maintain a mapping between virtual addresses and cache sets;
an anti-aliasing cache structure that is configured to maintain a mapping between virtual addresses and hashes of corresponding physical addresses stored in the primary cache structure; and
control logic that is configured to use the anti-aliasing cache structure to identify all instances of a particular physical address stored in the primary cache structure.

2. The cache system of claim 1, wherein the control logic is configured to use the anti-aliasing cache structure to identify all the instances of the particular physical address stored in the primary cache structure in a single cycle.

3. The cache system of claim 1, wherein the control logic is configured to detect aliasing, comprising:
computing a hash of the particular physical address;
determining, using the anti-aliasing cache structure, that two or more virtual addresses map to the hash of the particular physical address; and
in response to determining that the two or more virtual addresses map to the hash of the particular physical address, determining that the two or more virtual addresses have aliasing.

4. The cache system of claim 3, wherein the control logic is configured to remove the aliasing of the two or more virtual addresses.

5. The cache system of claim 1, wherein the control logic is configured to prevent aliasing, comprising:
receiving a request to fill the particular physical address into a first virtual address;
computing a hash of the particular physical address;
determining, using the anti-aliasing cache structure, that a second virtual address maps to the hash of the particular physical address;
evicting, in the primary cache structure, the second virtual address; and
filling, in the primary cache structure, the particular physical address into the first virtual address.

6. The cache system of claim 5, wherein preventing the aliasing further comprises:
evicting, in the anti-aliasing cache structure, the hash of the particular physical address associated with the second virtual address; and
associating, in the anti-aliasing cache structure, the hash of the particular physical address with the first virtual address.

7. The cache system of claim 1, wherein the anti-aliasing cache structure is indexed by a subset of bits of a virtual address, and wherein the subset of bits are the same during a translation from the virtual address to a corresponding physical address.

8. A method performed by a cache system, the method comprising:
maintaining, by a primary cache structure, a mapping between virtual addresses and cache sets;
maintaining, by an anti-aliasing cache structure, a mapping between virtual addresses and hashes of corresponding physical addresses stored in the primary cache structure; and
using the anti-aliasing cache structure to identify all instances of a particular physical address stored in the primary cache structure.

9. The method of claim 8, further comprising using the anti-aliasing cache structure to identify all the instances of the particular physical address stored in the primary cache structure in a single cycle.

10. The method of claim 8, further comprising detecting aliasing, comprising:
computing a hash of the particular physical address;
determining, using the anti-aliasing cache structure, that two or more virtual addresses map to the hash of the particular physical address; and
in response to determining that the two or more virtual addresses map to the hash of the particular physical address, determining that the two or more virtual addresses have aliasing.

11. The method of claim 10, further comprising removing the aliasing of the two or more virtual addresses.

12. The method of claim 8, further comprising preventing aliasing, comprising:
receiving a request to fill the particular physical address into a first virtual address;
computing a hash of the particular physical address;
determining, using the anti-aliasing cache structure, that a second virtual address maps to the hash of the particular physical address;
evicting, in the primary cache structure, the second virtual address; and
filling, in the primary cache structure, the particular physical address into the first virtual address.

13. The method of claim 12, wherein preventing the aliasing further comprises:
evicting, in the anti-aliasing cache structure, the hash of the particular physical address associated with the second virtual address; and
associating, in the anti-aliasing cache structure, the hash of the particular physical address with the first virtual address.

14. The method of claim 8, wherein the anti-aliasing cache structure is indexed by a subset of bits of a virtual address, and wherein the subset of bits are the same during a translation from the virtual address to a corresponding physical address.
